(19) United States
(12) Patent Application Publication
(10) Pub. No.: US 2025/0323433 A1
(43) Pub. Date: Oct. 16, 2025

(54) EARTH GROUNDING ELECTRODES, AND RELATED METHODS OF INSTALLATION AND USE

(71) Applicant: Paul Schneider, Edmonton (CA)

(72) Inventor: Paul Schneider, Edmonton (CA)

(21) Appl. No.: 19/082,498

(22) Filed: Mar. 18, 2025

(30) Foreign Application Priority Data
Apr. 12, 2024 (CA) 3,235,055

(51) Int. Cl. H01R 4/66

(52) U.S. Cl. CPC H01R 4/66

(57) ABSTRACT

An earth grounding electrode has a metal conductive base plate; and a metal conductive rod defined, in sequence, by a base part, a curved part, and an upright stub, with the base part secured to a top face of the metal conductive base plate, the curved part bent upward with a low-resistance radius of curvature, and the upright stub extended upward above, and inset within a volume that is defined, as projected from the top face and bounded by a peripheral edge of, the metal conductive base plate

### TECHNICAL FIELD

This document relates to earth grounding electrodes, and related methods of installation and use.

### BACKGROUND

The following paragraphs are not an admission that anything discussed in them is prior art or part of the knowledge of persons skilled in the art.

Earth grounding electrodes provide an interface between a neutral primary ground electrode of a power distribution system in a structure and the earth. Earth grounding electrodes typically have flat plates secured to a flexible electrode or a complex or awkward rod electrode.

### SUMMARY

An earth grounding electrode comprising: a metal conductive base plate; and a metal conductive rod defined, in sequence, by a base part, a curved part, and an upright stub, with the base part secured to a top face of the metal conductive base plate, the curved part bent upward with a low-resistance radius of curvature, and the upright stub extended upward above, and inset within a volume that is defined, as projected from the top face and bounded by a peripheral edge of, the metal conductive base plate.

In various embodiments, there may be included any one or more of the following features: The curved part is bent upward with a radius of curvature of two and a half inches or more. The curved part is bent upward with a radius of curvature of three inches or more. The metal conductive rod comprises a bent rod of ⅝″ diameter or greater. The base part is secured against and along the top face of the metal conductive base plate with an axis of the base part being parallel with a plane defined by the top face. The curved part forms a 90-degree elbow. The base part is mounted above a center of the top face of the metal conductive base plate. The metal conductive base plate comprises a rectangular plate with a length of the top face greater than a width of the top face. The length is two and a half times greater than the width or more. The base part is mounted transverse to a longitudinal axis of the rectangular plate, at or adjacent an end edge of the horizontal base part. A conductor clamp mounted at or near a top end of the upright stub. Embedded in earth within or below a footing or floor of a foundation, in contact with native soil, with the upright stub extended through and above the footing or floor. The upright stub is below a main distribution panel in a building above the footing or floor. Concrete reinforcing rebar tied or connected to the metal conductive rod and embedded within the footing or floor. The base part is welded to the top face of the metal conductive base plate. In use: the upright stub is oriented vertically; and the base part is oriented horizontally. A method comprising embedding the metal conductive base plate of the earth grounding electrode in the ground. Embedding the metal conductive rod in concrete. Electrically connecting a terminal end of the upright stub part to a neutral electrode (such as a terminal or bus bar) in an electrical power distribution system of a structure. The metal conductive rod is a galvanized metal conductive rod.

The foregoing summary is not intended to summarize each potential embodiment or every aspect of the subject matter of the present disclosure. These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is a perspective view of an earth grounding electrode with a galvanized metal conductive rod within a concrete form for a footing of a building.

FIG. 2 is a perspective view of the earth grounding electrode of FIG. 1.

FIG. 3 is a side elevation view of the earth grounding electrode of FIG. 1.

FIG. 4 is a front-end view of the earth grounding electrode of FIG. 1.

FIG. 4A is a close-up view of the circular area in FIG. 4 denoted by dashed lines and reference numeral 4A.

FIG. 5 is a perspective view of the earth grounding electrode of FIG. 1 within a concrete form for a footing or floor of a building, with rebar tied to the rod.

FIG. 6 is a top plan view of the earth grounding electrode of FIG. 1, with the galvanized metal conductive rod installed in the center of the earth grounding electrode.

FIG. 7 is a top plan view of the earth grounding electrode of FIG. 1, with the galvanized metal conductive rod installed off center of the earth grounding electrode.

FIG. 8 is a top plan view of the earth grounding electrode of FIG. 1 within a concrete form for a footing of a building.

FIG. 9 is a top plan view of a clamp to connect the galvanized metal conductive rod of the earth grounding electrode of FIG. 1 to a neutral wire.

FIG. 10 is a section view of the earth grounding electrode of FIG. 1 installed in a building.

FIG. 11 is a section view of the earth grounding electrode of FIG. 1 installed in a footing of a building, not yet connected to a distribution panel.

### DETAILED DESCRIPTION

Immaterial modifications may be made to the embodiments described here without departing from what is covered by the claims.

Electricity systems in buildings comprise intricate networks of electrical components designed to distribute power efficiently and safely throughout the structure. These systems typically consist of a connection to a power source, such as a utility grid or an on-site generator, which feeds electricity into a distribution panel or panel system. From there, the electricity is routed through circuits, wires, and outlets to power various devices and appliances within the building. Safety measures, such as circuit breakers and grounding systems, are added to protect against overloads, shorts, and electrical hazards.

Electricity grounding is an aspect of an electrical system. A grounding system is designed to provide a safe path for excess or spent electrical current to dissipate into the ground, thereby preventing electrical shocks, fires, and equipment damage. Grounding typically involves connecting metal components of an electrical system, such as electrical panels, outlets, and equipment enclosures, to the earth via an earth grounding electrode system. A grounding connection establishes a low-resistance pathway for fault currents to flow safely away from conductive surfaces and into the ground. Grounding also helps to stabilize voltage levels, reduce electromagnetic interference, and improve the effectiveness of overcurrent protection devices like circuit breakers and fuses. Compliance with grounding standards and regulations is essential to ensure the effectiveness and safety of electrical systems in both residential and commercial buildings.

In electrical engineering, ground or earth may be a reference point in an electrical circuit from which voltages are measured, a common return path for electric current, or a direct physical connection to the Earth.

Electrical circuits may be connected to ground for several reasons. Exposed conductive parts of electrical equipment are connected to ground, to protect users from electrical shock hazard. If internal insulation fails, dangerous voltages may appear on the exposed conductive parts. Connecting exposed conductive parts to a “Ground” wire which provides a low-impedance path for current to flow back to the incoming Neutral (which is also connected to Ground, close to the point of entry) will allow circuit breakers (or RCDs) to interrupt power supply in the event of a fault. In electric power distribution systems, a protective earth (PE) conductor is an essential part of the safety provided by the earthing system.

Connection to ground also limits the build-up of static electricity when handling flammable products or electrostatic-sensitive devices. In some telegraph and power transmission circuits, the ground itself can be used as one conductor of the circuit, saving the cost of installing a separate return conductor (see single-wire earth return and earth-return telegraph).

For measurement purposes, the Earth serves as a (reasonably) constant potential reference against which other potentials can be measured. An electrical ground system should have an appropriate current-carrying capability to serve as an adequate zero-voltage reference level. In electronic circuit theory, a “ground” is usually idealized as an infinite source or sink for charge, which can absorb an unlimited amount of current without changing its potential. Where a real ground connection has a significant resistance, the approximation of zero potential is no longer valid. Stray voltages or earth potential rise effects will occur, which may create noise in signals or produce an electric shock hazard if large enough.

The use of the term ground (or earth) is so common in electrical and electronics applications that circuits in portable electronic devices, such as cell phones and media players, as well as circuits in vehicles, may be spoken of as having a “ground” or chassis ground connection without any actual connection to the Earth, despite “common” being a more appropriate term for such a connection. That is usually a large conductor attached to one side of the power supply (such as the “ground plane” on a printed circuit board), which serves as the common return path for current from many different components in the circuit.

Electrical power distribution systems are often connected to earth ground to limit the voltage that can appear on distribution circuits. A distribution system insulated from earth ground may attain a high potential due to transient voltages caused by static electricity or accidental contact with higher potential circuits. An earth ground connection of the system dissipates such potentials and limits the rise in voltage of the grounded system.

Equipment bonding conductors or equipment ground conductors (EGC) provide a low-impedance path between normally non-current-carrying metallic parts of equipment and one of the conductors of that electrical system's source. If any exposed metal part should become energized (fault), such as by a frayed or damaged insulator, it creates a short circuit, causing the overcurrent device (circuit breaker or fuse) to open, clearing (disconnecting) the fault. It is important to note this action occurs regardless of whether there is a connection to the physical ground (earth); the earth itself has no role in this fault-clearing process since current must return to its source; however, the sources are very frequently connected to the physical ground (earth). (see Kirchhoff's circuit laws). By bonding (interconnecting) all exposed non-current carrying metal objects together, as well as to other metallic objects such as pipes or structural steel, they should remain near the same voltage potential, thus reducing the chance of a shock. This is especially important in bathrooms where one may be in contact with several different metallic systems such as supply and drain pipes and appliance frames. When a conductive system is to be electrically connected to the physical ground (earth), one puts the equipment bonding conductor and the grounding electrode conductor at the same potential.

Permanently installed electrical equipment, unless not required to, has permanently connected grounding conductors. Portable electrical devices with metal cases may have them connected to earth ground by a pin on the attachment plug (see AC power plugs and sockets). The size of power grounding conductors is usually regulated by local or national wiring regulations.

Strictly speaking, the terms grounding or earthing are meant to refer to an electrical connection to ground/earth. Bonding is the practice of intentionally electrically connecting metallic items not designed to carry electricity. This brings all the bonded items to the same electrical potential as a protection from electrical shock. The bonded items can then be connected to ground to eliminate foreign voltages.

In electricity supply systems, an earthing (grounding) system defines the electrical potential of the conductors relative to that of the Earth's conductive surface. The choice of earthing system has implications for the safety and electromagnetic compatibility of the power supply. Regulations for earthing systems vary considerably between different countries. A functional earth connection serves more than protecting against electrical shock, as such a connection may carry current during the normal operation of a device. Such devices include surge suppression, electromagnetic-compatibility filters, some types of antennas, and various measurement instruments. Generally, the protective earth system is also used as a functional earth, though this requires care.

An earth grounding system in a building comprises several components to ensure effective electrical safety and performance. The primary component is the earth grounding electrode system, which typically consists of metal rods or plates buried in the earth near the building's foundation. These electrodes provide a low-resistance path for fault currents to dissipate safely into the ground. Connected to the grounding electrodes are grounding conductors, typically made of copper or aluminum, which run from the electrodes to the main electrical service panel. Within the panel, these conductors connect to the neutral bus bar, which is bonded to the building's structural steel and other metal components. Additionally, bonding jumpers or conductors establish connections between metal conduits, electrical boxes, and exposed metal surfaces throughout the building, ensuring comprehensive protection and minimizing the risk of electrical hazards.

Ground plates, also known as grounding plates or earth plates, are a main component of earth grounding electrode systems in electrical installations. Ground plates are typically made of conductive materials such as copper, steel, or aluminum and are buried underground near, within, or below the building's foundation. A ground plate provides a low-resistance connection to the earth, serving as an efficient pathway for fault currents to dissipate safely. The size and configuration of ground plates vary depending on factors such as soil resistivity and the electrical load of the building. It may be helpful to have ground plates installed in areas with adequate soil moisture and conductivity to ensure optimal performance. Proper installation techniques, including ensuring good contact between the plate and the surrounding soil, are necessary to maximize conductivity. Regular testing and maintenance may be beneficial to verify the integrity of ground plates and ensure the effectiveness of the grounding system in providing electrical safety and stability within the building.

Connecting a ground plate to a distribution panel involves several steps to ensure effective grounding within an electrical system. Firstly, a grounding conductor, typically made of copper or aluminum, is run from the ground plate location to the distribution panel. This conductor serves as the pathway for fault currents to flow from the electrical system into the ground/earth grounding electrode. Within the distribution panel, the grounding conductor is terminated onto the neutral bus bar, which is a metal strip designed to provide a common connection point for all grounding conductors in the system. The neutral bus bar is securely bonded to the panel's metal enclosure, ensuring continuity and low resistance throughout the grounding system. Proper installation techniques, including securely fastening and tightening connections, are essential to maintain conductivity and prevent corrosion over time.

Ground plates and earth grounding electrodes are often galvanized to enhance their durability and longevity in underground environments. Galvanization involves coating the surface of the ground plate with a layer of zinc, which provides excellent corrosion resistance. This protective zinc coating acts as a barrier, preventing moisture, soil chemicals, and other corrosive agents from reaching the underlying metal substrate. As a result, galvanized ground plates exhibit superior resistance to rust and corrosion, even in harsh soil conditions or areas with high moisture levels. This increased resistance to corrosion ensures that the ground plates maintain their conductivity and effectiveness as part of the grounding system over an extended period. Additionally, the galvanized coating helps to maintain electrical continuity and low resistance, crucial for the efficient dissipation of fault currents into the earth, thereby contributing to the overall safety and reliability of the electrical installation.

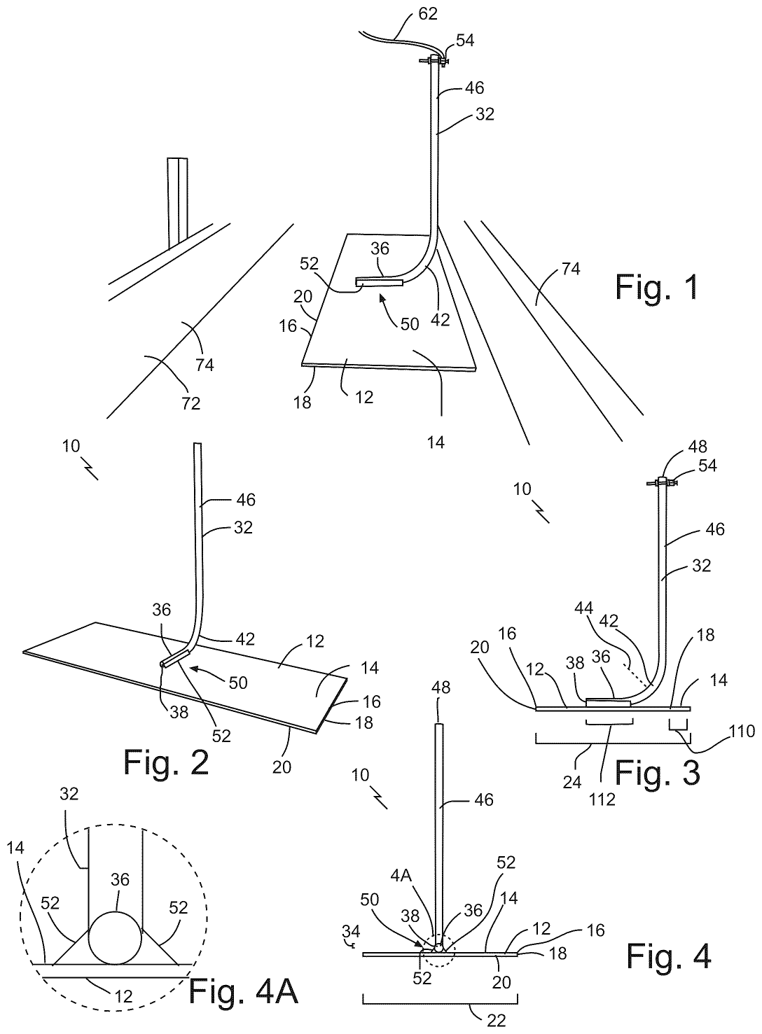

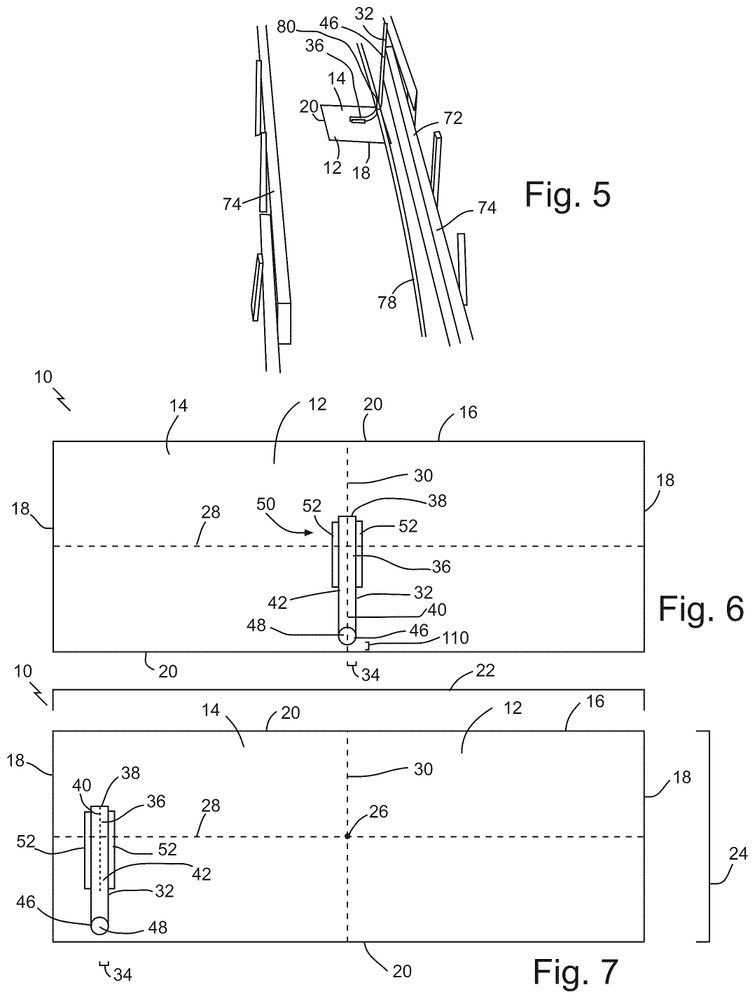

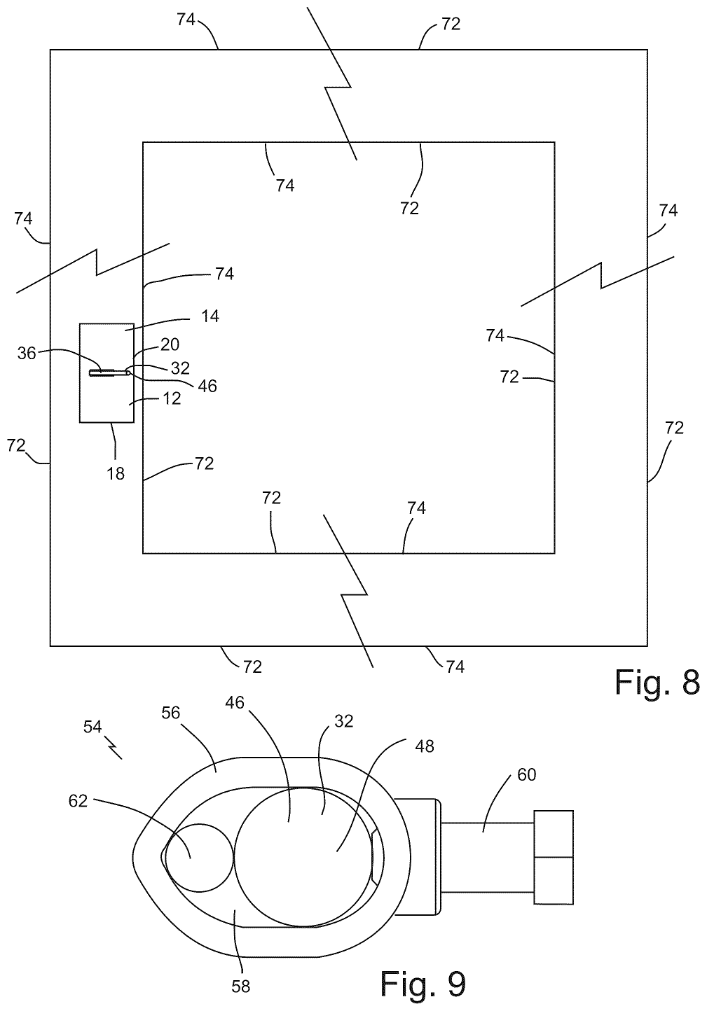

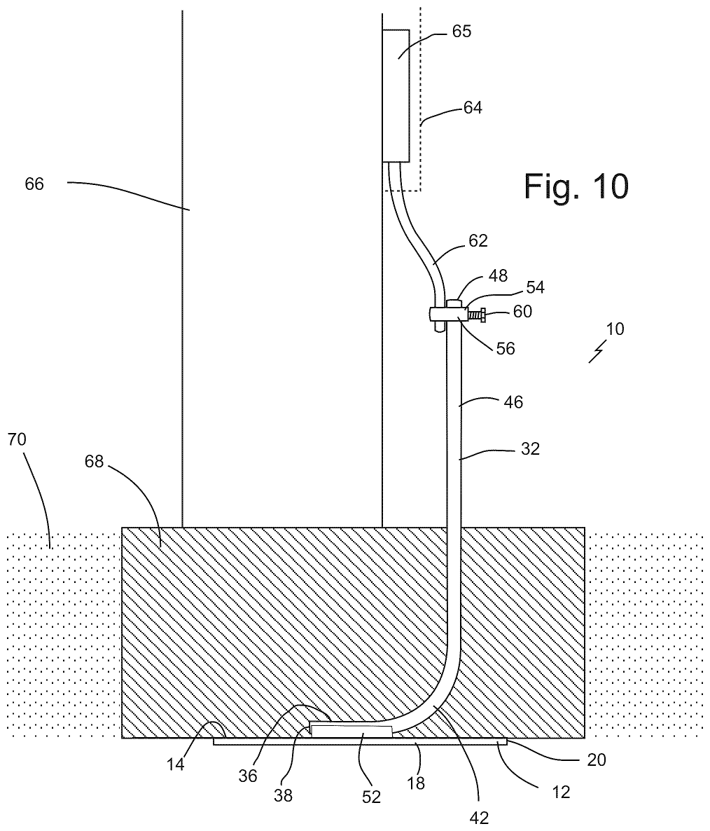

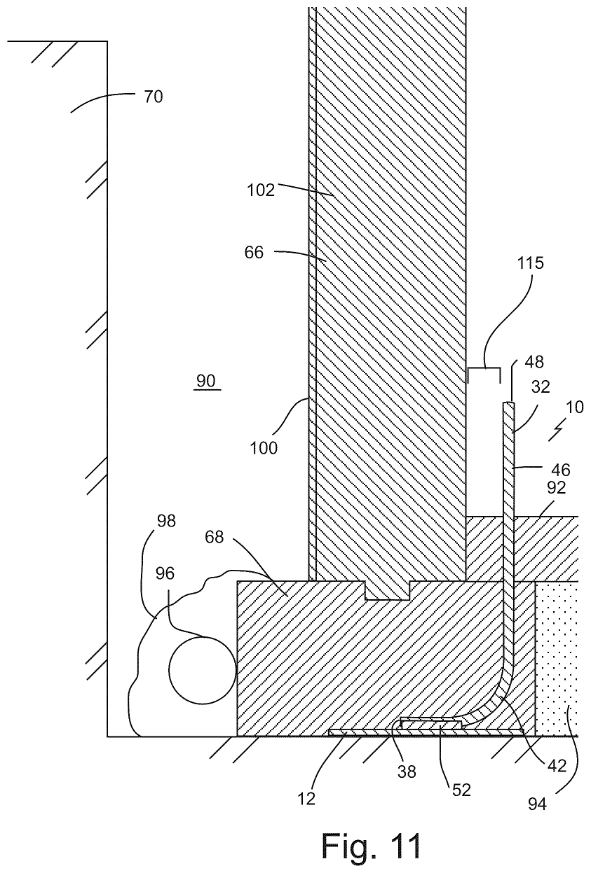

Referring to FIGS. 1-8 and 10, an earth grounding electrode 10 is disclosed. The earth grounding electrode 10 comprises a metal conductive base plate 12, such as a flat plate 12, and a galvanized metal conductive rod 32. The rod 32 may be defined, in sequence, by a base part 36, a curved part 42, and an upright stub part 46. The base part 36 may be secured to a top face 14 of the flat metal conductive base plate 12. The curved part 42 may be bent upward with a low-resistance radius of curvature 44. The upright stub part 46 may be extended upward above, and inset within a volume that is defined, as projected from the top face 14 and bounded by a peripheral edge 16 of, the metal conductive base plate 12. Referring to FIGS. 6 and 7, the volume may be visualized as the volume of space defined by the top face and that projects from the top face to infinity.

Referring to FIGS. 1-8 and 10, the metal conductive base plate 12 has a suitable structure. The plate 12 may be flat. The top face 14 of the plate 12 may be defined within the area bounded by a peripheral edge 16 of the plate 12. The plate 12 may define end edges 18 and side edges 20, and the edges 18 and 20 may collectively make up the peripheral edge 16. The end edges 18 may define a suitable width 24 of the plate 12. The side edges 20 may define a suitable length 22 of the plate 12. The metal conductive base plate 12 may form a rectangular plate 12 with a length 22 of the top face 14 greater, such as two and a half times greater, than a width 24, of the top face 14. Suitable materials and dimensions may be used, such as steel for the plate and conductor rod, a ⅝ in. bronze ground connector rod 32, and 10 in.×15 in.×¼ in for plate 12, although other dimensions larger or smaller may be used.

Referring to FIGS. 1-8 and 10, the conductive rod 32 may have a suitable structure. The rod 32 may extend in sequence, from the top face 14, via base part 36, curved part 42, and vertical stub part 46. The aforementioned parts of rod 32 may be connected by suitable methods, such if the rod parts are integrally formed from a single bent rod as shown. The galvanized metal conductive rod 32 may have a suitable diameter, such as a bent ⅝″ diameter rod. With a ⅝″ rod, the radius 34 may be 5/16″. The conductive rod 32 may be galvanized to improve durability and conductivity of the rod 32.

Referring to FIGS. 1-8 and 10, the base part 36 of the rod 32 may have a suitable structure. The base part 36 may define a terminal end 38 of the rod 32. The base part 36 may be secured to the plate 12 by a suitable means, for example, via welding, as visualized by the example pair of welds 52 that run longitudinally along the opposed sides of base part 36 to secure base part 36 electrically and stably to the top face 14. In the example shown, base part 36 may form a tee joint 50 weld with the base plate 12. The curved part 42 may stem from the horizontal base part 36. The rod 32 may be connected to the top face 14 of the plate 12 at an appropriate location on the plate 12. The horizontal base part 36 may be mounted above a center 26 of the top face 14 of the flat metal conductive base plate 12. The center 26 of the plate 12 may be defined as the intersection between a major axis 28 and a minor axis 30. The base part 36 may be mounted transverse to the major axis 28, such as a longitudinal axis as shown, at any point along the axis 28. An axis 40 of the base part 36 may align with the minor axis 30 of the plate 12. The horizontal base part 36 may mounted transverse to a major axis 28 of the rectangular plate 12, at or adjacent an end edge 18 of the base part 32. The location in volume of the plate 12 may be bounded by the peripheral edge 16 of the plate 12. The base part 36 may be secured against and along the top face 14 of the metal conductive base plate 12 with an axis 40 of the base part being parallel with a plane defined by the top face 14, such as if the base part 36 forms a straight (unbent) solid cylinder that is secured flat against and along the top face 14 as shown.

Referring to FIG. 4A, the weldment or welds 52 may be built up in plural layers for added thickness, to form a continuous metal to metal integral connection with the base plate 12 that facilitates minimal electrical resistance current passage therethrough. In the example shown, the welds 52 are built up to give the base part 36, welds 52, and base plate 12 a symmetrical trapezoidal shape in cross-section (with the exception of the curved top of the base part 36 in the case shown). Referring to FIG. 3, the welds 52 may run a suitable minimum length 112, such as three inches minimum length, and may be adhered to both opposed sides of base part 36, forming a contiguous base without gaps. A build up of weldment in such a fashion may create a larger surface area for galvanizing to adhere to, such as via a hot dip galvanizing process, for example carried according to relative standards in place in the area of sale and/or use, such as according to Canadian Standards Association (CSA) standards. Centralization of the rod on the plate may provide the most efficient dissipation of current into the earth, without accumulating or focusing energy in smaller areas as is the case with edge mounted rods. In the example shown may be cheaper and more convenient to manufacture, than a plate with a gusset, as it may be made by a simpler procedure, and may use less steel, and less weldment (such as from a welding rod). A suitable welding method may be used such as by using 6010 welding rod as a root/base, and 7014 as cover weld (weld 52) to provide a wider surface area of coverage for galvanizing. The use of a suitable welding technique that cuts through mill scale on the plate and rod may be used.

Referring to FIGS. 1-8 and 10, the curved part 42 of the rod 32 may have a suitable structure. The curved part 42 may be bent upward with a suitable radius of curvature 44, for example, a radius of curvature 44 of two and half or three inches or more. A 3″ weld with 3″ radius may permit the stub to be sufficiently inset within edge 20 on a 10″ wide plate 12. The radius of curvature of metal can affect the flow of electricity through the metal, primarily due to the phenomenon known as “skin effect” and, to some extent, “proximity effect”. The skin effect is the tendency of alternating current (AC) to flow primarily near the surface of a conductor, rather than evenly distributing across its cross-section. When the metal is curved sharply, this effect becomes more pronounced, as the effective surface area for current flow decreases. As a result, the effective resistance of the metal increases, leading to higher energy losses and reduced efficiency in conducting electricity. The proximity effect causes the current to concentrate on the outer edges of adjacent conductors, leading to uneven current distribution and increased resistance, particularly in curved metal conductors. Metal with a low radius of curvature can increase the resistance to electrical current flow due to the skin effect and proximity effect, resulting in higher energy losses and reduced efficiency in conducting electricity. High resistance bends, such as below two inches of curvature in a ⅝″ rod, may create enough resistance that additional conductive parts must be added to the rod, such as vertical plates or buttressing, to reduce resistance to flow. The proximity effect also plays a role, especially in AC systems with high currents. Therefore, minimizing sharp bends and maintaining smooth, gradual curves in metal conductors may help mitigate these effects and optimize electrical performance. A relatively larger radius of curvature 44 may lower the resistance to electrical current flow due to the skin effect and proximity effect, resulting in a more efficient conductive rod 32. The curved part 42 may form a 90-degree elbow, for example as shown.

Referring to FIGS. 1-8 and 10, the upright stub part 46 may have a suitable structure. The upright stub part 46 may form a stem off an end of the curved part 42. The upright stub part 46 may define a terminal end 48 of the rod 32. The upright stub part 46 may be oriented transverse the base part 36 and/or top face 14, for example perpendicular to a plane defined by top face 14, such as if the stub part 46 forms a straight (unbent) solid cylinder that in use extends vertically relative to the horizontal top face 14 of plate 12 as shown. The stub part 46 may extend entirely above the top face 14 of plate 12 in use, for example inset within the boundary of the peripheral edge 16. Mounting the upright stub part 46 to extend within the volume projected upward of the plate 12 may reduce the lateral footprint of the electrode 10.

In electrical engineering, ground and neutral (earth and neutral) are circuit conductors used in alternating current (AC) electrical systems. The neutral conductor returns current to the supply. To limit the effects of leakage current from higher-voltage systems, the neutral conductor is often connected to earth ground at the point of supply. A ground conductor is not intended to carry current for normal operation of the circuit, but instead connects exposed metallic components (such as equipment enclosures or conduits enclosing wiring) to earth ground. A ground conductor only carries significant current if there is a circuit fault that would otherwise energize exposed conductive parts and present a shock hazard. Circuit protection devices may detect a fault to a grounded metal enclosure and automatically de-energize the circuit, or may provide a warning of a ground fault. Under certain conditions, a conductor used to connect to a system neutral is also used for grounding (earthing) of equipment and structures. Current carried on a grounding conductor can result in objectionable or dangerous voltages appearing on equipment enclosures, so the installation of grounding conductors and neutral conductors is carefully defined in electrical regulations. Where a neutral conductor is used also to connect equipment enclosures to earth, care must be taken that the neutral conductor never rises to a high voltage with respect to local ground. A neutral is a circuit conductor that normally completes the circuit back to the source. NEC states that the neutral and ground wires should be connected at the neutral point of the transformer or generator, or otherwise some “system neutral point” but not anywhere else. The aforementioned is for simple single panel installations; for multiple panels the situation is more complex. In a polyphase (usually three-phase) AC system, the neutral conductor is intended to have similar voltages to each of the other circuit conductors, but may carry very little current if the phases are balanced.

All neutral wires of the same earthed (grounded) electrical system should have the same electrical potential, because they are all connected through the system ground. Neutral conductors are usually insulated for the same voltage as the line conductors, with interesting exceptions. Neutral wires are usually connected at a neutral bus within panelboards or switchboards, and are “bonded” to earth ground at either the electrical service entrance, or at transformers within the system. For electrical installations with split-phase (three-wire single-phase) service, the neutral point of the system is at the center-tap on the secondary side of the service transformer. For larger electrical installations, such as those with polyphase service, the neutral point is usually at the common connection on the secondary side of delta/wye connected transformers. Other arrangements of polyphase transformers may result in no neutral point, and no neutral conductors.

Referring to FIGS. 1, 3, 9 and 10, the electrode 10 may connect to a neutral conductor 62 in use. In the example shown, the electrode 10 may be structured to connect to a conductor 62 via a suitable mechanism such as a conductor clamp 54. Clamp 54 may be mounted at or near a top end 48 of the upright stub part 46. The clamp 54 may have a clamp body 56. The clamp body 56 may define a through-aperture 58 that defines a wire and rod passage as shown. The aperture 58 may be sized to receive the upright stub part 46 and a neutral conductor 62. The clamp 54 may comprise a threaded fastener 60, latch, or other systems for securing the wire and rod in conductive contact together. Once the conductor 62 and stub part 46 are oriented within the clamp 54, the fastener 60 may be tightened to secure the stub part 46 and neutral conductor 62 within the aperture 58. The neutral conductor 62 may lead to a distribution panel 64, where the conductor 62 may be connected to a neutral bus bar 65. The conductor 62 may be any suitable wire, such as a cable or braided cable. The conductor 62 may connect the electrode 10 to the bus bar 65 and in turn to the rest of the grounding conductors in the electrical system of the building 66.

Referring to FIGS. 1, 5, 8 and 10, the earth grounding electrode 10 may be installed a suitable location for a building 66 or other structure, for example if buried underground near the footing 68 or floor of the building 66. In a new construction scenario, the electrode 10 would be typically installed within the footing 68. However, in a renovation or retrofit scenario on an existing structure, it may be more common to mount the electrode 10 within a floor of the building 66 or structure. The electrode 10 may be placed at strategic locations around the perimeter of the building 66 to ensure effective grounding of the electrical system of the building 66. The exact placement of the earth grounding electrode 10 may vary depending on factors such as the size and layout of the building 66, conditions of the soil 70, local electrical codes, and proximity to the expected location of the electrical panel. Earth grounding electrodes 10 may be installed near metal structures or equipment within the building 66 that require grounding, such as distribution (electrical) panels 64 or large machinery. The upright stub part 46 may be below, for example directly vertical below, a main distribution panel 64 in a building 66 above the footing 68. The earth grounding electrode 10 may be positioned in areas where the electrode 10 is able to provide a low-resistance path for fault currents to dissipate safely into the soil 70, thereby increasing the electrical safety of the building 66.

Referring to FIGS. 1, 5, 8 and 10, the earth grounding electrode 10 may be installed during the construction of the building 66 or other structure. The earth grounding electrode 10 may be embedded in earth, at least partially within or below a footing 68 of a foundation, with the upright stub part 46 extended above the footing 68. The plate electrode 10 may be installed within a temporary concrete form 72 during the construction of the footing 68. The form 72 may be formed by beams 74 and cross beams. Concrete formwork may include temporary molds into which concrete or similar materials are cast-in-place. In the context of concrete construction, the falsework supports the shuttering molds. In specialty applications formwork may be permanently incorporated into the final structure, adding insulation or helping reinforce the finished structure. Concrete may be poured into forms 72 using a systematic process to ensure proper placement and consolidation. The concrete may be poured into the forms 72 using equipment such as concrete pumps, buckets, or wheelbarrows, depending on the size of the footing 68. After the concrete has cured to the appropriate strength, the forms 72 may be dismantled or removed to reveal the finished concrete structure. The concrete may be used to secure the electrode 10 in place within the footing 68 or floor. Reinforcing steel bars, commonly known as rebar 78, may incorporated to provide structural strength and stability to the concrete. Before concrete is poured, rebar 78 may be strategically placed within the forms 72 according to engineering specifications and project requirements. The rebar 78 may be tied together using rebar ties 80 to form a grid or framework, creating a reinforcement structure that helps distribute loads and resist tensile forces within the concrete. In the example shown the rebar 78 is tied to rod 32. As the concrete is poured into the forms 72, it may surround and encase the rebar 78, forming a composite material known as reinforced concrete. The combination of concrete and rebar 78 may enhance the overall strength, durability, and resistance to cracking and structural failure of the concrete. The reinforcing rebar 78 in the footing 68 may be tied or connected to the galvanized metal conductive rod 32 and embedded within the footing 68, for example using rebar ties 80. Tying the rod to the rod may improve dissipation of current.

Referring to FIG. 11, the earth grounding electrode 10 may be installed in the footing 68 of a building 66. The electrode 10 may be cast within a concrete form during the formation of the footing 68 and may be cemented in place. In some cases, the footing 68 of the building may be at or near the surface of the soil 70. In other cases, the footing 68 of the building may be substantially below the surface of the soil 70, for example when the building 66 has a basement, such as shown in the figure where the footing 68 is within an excavated hole 90. The vertical stub part may be located 4″ or greater from the inside of the concrete foundation wall. The metal conductive rod 32 may be sized to extend through the footing 68, through a floor surface (such as slab 92) and into the interior of the building 66. Referring to FIG. 11, the plate 12 may be positioned such that the vertical stub part 46 is a suitable distance from the inside face of the wall 102, such as 3-4″, or greater. Other structural elements may be added around the footing 68 to complete the foundation, such as a concrete cast floor 92, a concrete cast foundation wall 102, an air gap membrane 100, weeping tile 96, and crushed stone 94 and 98.

Referring to FIGS. 1-8 and 10, the electrode 10 may be retrofitted to an existing building 66. Installing an earth grounding electrode 10 to an already constructed building 66 may involve locating a suitable area near the footing 68 of the building 66 or soil 70 surrounding the building where earth grounding electrode 10 may be buried without causing damage to the building 66. Excavation of the footing 68 and/or the soil 70 may be necessary to create trenches for laying grounding conductors, which may connect the earth grounding electrode 10 to the building's electrical system. Specialized equipment and techniques may be employed to minimize disturbance to the surrounding area. Once the earth grounding electrode 10 is installed and connected, testing and verification procedures may be conducted to ensure the effectiveness of the grounding system.

Words such as vertical, horizontal, up, down, upward, downward, above, below, and others are understood to be relative terms and not to be construed as absolute orientations defined with respect to the direction of gravitational acceleration on the earth, unless context dictates otherwise.

Referring to FIGS. 3 and 6, the base part 36 may be located sufficiently inward of the side edges of the plate 12 that a horizontal gap 110 of two inches or more is present between the closest edge 20 and the vertical stub part 46 is defined, when viewed from above and the parts projected into the same plane. Insetting the rod within the edges 20 may also help the product nest one over the other for efficient shipping. The plate 12 may have a suitable surface area, such as a two square feet or greater. The vertical stub part may extend a suitable vertical height such as nineteen inches or more above the plate 12. A suitable diameter of rod may be used, such as ⅝″ or greater. Galvanizing may go on to a suitable extent, such as a 4 mm or greater. The product shown may be rated for a suitable amperage, such as less than 1000 A service.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

### PART LIST

10 earth grounding electrode
12 metal conductive base plate, galvanized after fabrication
14 top face
16 peripheral edge
18 end edges
20 side edges
22 length side edges
24 length end edges
26 center of top surface
28 major axis
30 minor axis
32 metal conductive rod, galvanized after fabrication
34 radius
36 a base part
38 terminal end
40 axis
42 curved part
44 radius of curvature
46 vertical stub part
48 terminal top end
50 tee joint
52 welds
54 clamp
56 body
58 aperture
60 threaded fastener
62 neutral conductor
64 distribution panel
65 neutral bar
66 building
68 footing
70 earth/ground surface below footing
72 temporary concrete form
74 beams
78 rebar
80 rebar ties
92 floor
94 and 98 crushed gravel
96 weeping tile
100 membrane
102 foundation wall
110 distance between plate edge and vertical stub part
112 length of welds 52
115 distance between vertical stub part and wall 102

1. An earth grounding electrode comprising:
a metal conductive base plate; and
a metal conductive rod defined, in sequence, by a base part, a curved part, and an upright stub, with the base part secured to a top face of the metal conductive base plate, the curved part bent upward with a low-resistance radius of curvature, and the upright stub extended upward above, and inset within a volume that is defined, as projected from the top face and bounded by a peripheral edge of, the metal conductive base plate.

2. The earth grounding electrode of claim 1 in which the curved part is bent upward with a radius of curvature of two and a half inches or more.

3. The earth grounding electrode of claim 2 in which the curved part is bent upward with a radius of curvature of three inches or more.

4. The earth grounding electrode of claim 1 in which the metal conductive rod comprises a bent rod of ⅝″ diameter or greater.

5. The earth grounding electrode of claim 1 in which the base part is secured against and along the top face of the metal conductive base plate with an axis of the base part being parallel with a plane defined by the top face.

6. The earth grounding electrode of claim 1 in which the curved part forms a 90-degree elbow.

7. The earth grounding electrode of claim 1 in which the base part is mounted above a center of the top face of the metal conductive base plate.

8. The earth grounding electrode of claim 1 in which the metal conductive base plate comprises a rectangular plate with a length of the top face greater than a width of the top face.

9. The earth grounding electrode of claim 8 in which the length is two and a half times greater than the width or more.

10. The earth grounding electrode of claim 9 in which the base part is mounted transverse to a longitudinal axis of the rectangular plate, at or adjacent an end edge of the horizontal base part.

11. The earth grounding electrode of claim 1 further comprising a conductor clamp mounted at or near a top end of the upright stub.

12. The earth grounding electrode of claim 1 embedded in earth within or below a footing or floor of a foundation, in contact with native soil, with the upright stub extended through and above the footing or floor.

13. The earth grounding electrode of claim 12 in which the upright stub is below a main distribution panel in a building above the footing or floor.

14. The earth grounding electrode of claim 1 in which the base part is welded to the top face of the metal conductive base plate.

15. The earth grounding electrode of claim 1 in which, in use:
the upright stub is oriented vertically; and
the base part is oriented horizontally.

16. The earth grounding electrode of claim 1 in which the metal conductive rod is galvanized.

17. A method comprising embedding the metal conductive base plate of the earth grounding electrode of claim 1 in the ground.

18. The method of claim 17 further comprising embedding the metal conductive rod in concrete.

19. The method of claim 17 further comprising electrically connecting a terminal end of the upright stub part to a neutral terminal or bus bar in an electrical power distribution system of a structure.
